(19) United States
(12) Patent Application Publication
(10) Pub. No.: US 2015/0324287 A1
(43) Pub. Date: Nov. 12, 2015

(54) A METHOD AND APPARATUS FOR USING A CPU CACHE MEMORY FOR NON-CPU RELATED TASKS

(71) Applicants: Michael PRIEL, Netanya (IL); Yossi AMON, Kiryat Tivon (IL); Boris SHULMAN, Holon (IL); Leonid SMOLYANSKY, Zichron Yakov (IL); Michael ZARUBINSKY, Rishon Lezion (IL)

(72) Inventors: MICHAEL PRIEL, NETANYA (IL); YOSSI AMON, KIRYAT TIVON (IL); BORIS SHULMAN, HOLON (IL); LEONID SMOLYANSKY, ZICHRON YAKOV (IL); MICHAEL ZARUBINSKY, RISHON LEZION (IL)

(73) Assignee: Freescale Semiconductor, Inc., Austin, TX (US)

(21) Appl. No.: 14/655,109

(22) PCT Filed: Jan. 9, 2013
(86) PCT No.: PCT/IB2013/050185

§ 371 Date: Jun. 24, 2015

(51) Int. Cl. G06F 12/08

(52) U.S. Cl. CPC G06F 12/0802; G06F 2212/1052; G06F 2212/251

(57) ABSTRACT

There is provided a processor for use in a computing system, said processor including at least one Central Processing Unit (CPU), a cache memory coupled to the at least one CPU, and a control unit coupled to the cache memory and arranged to obscure the existing data in the CPU cache memory, and assign control of the CPU cache memory to at least one other entity within the computing system. There is also provided a method of using a CPU cache memory for non-CPU related tasks in a computing system.

### FIELD OF THE INVENTION

This invention relates to computing systems in general, and in particular to a method and apparatus for using a CPU cache memory for non-CPU related tasks.

### BACKGROUND OF THE INVENTION

The processors that power modern computing devices not only include one or more logical processing units (PUs), for example processing cores, to carry out computational processing on data, but they also often include at least some local low-latency fast-access storage space, for storing the data processing instructions and/or data to be processed and/or data as it is processed. This local low-latency fast-access storage space is often referred to a local cache memory, and is usually provided for the exclusive use of one or more processing units or cores in the processor device. Often, the local cache is now physically included on the same semiconductor die as the processing units or cores themselves.

As cache memories increase in size, and therefore the area they take up on a semiconductor die, their inclusion in a processor becomes relatively more expensive.

Furthermore, power consumption of computing devices is becoming an ever more important issue.

### SUMMARY OF THE INVENTION

The present invention provides a processor for use in a computing system as described in the accompanying claims.

Specific embodiments of the invention are set forth in the dependent claims.

The present invention also provides a method of using a CPU cache memory for non-CPU related tasks.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows a schematic diagram of a first discrete processor based example computing system to which the invention may apply;

FIG. 2 shows a schematic diagram of a second System on Chip (SoC) integrated multimedia processor based example computing system to which the invention may apply;

FIG. 3 shows a more detailed schematic diagram of an example SoC computing system according to an example of the invention;

FIG. 4 shows an example hardware implementation of the cache control architecture according to an example of the invention;

FIG. 5 shows an example data flow path within the example of FIG. 4;

FIG. 6 shows an example flow diagram of a method of controlling CPU cache memory use by an entity external to the CPU for which the cache is originally provided according to an example embodiment of the invention.

### DETAILED DESCRIPTION OF THE PREFERRED EMBODIMENTS

Because the illustrated embodiments of the present invention may for the most part be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Taking a specific use-case as an example, in many low activity use-cases (e.g. where only relatively few CPU MIPS are required, and/or where the CPU is being placed into a standby/low power mode relatively regularly), e.g. multimedia playback on a handheld tablet device, the total system power consumption may be of interest (or even critical in low power scenarios).

These low activity use-cases may not be using much data processing resources (e.g. MIPS), but they often still make use of significant data storage resources and/or data transfers (e.g. memory accesses to and from external memory), often but not exclusively to provide some kind of memory buffer for storing data, for example the multimedia content that is to be output by the computing system in the multimedia playback example above.

Using a sufficiently sized on-chip memory storage facility would be very beneficial in these sorts of use-cases, because it would allow a reduction in activity on the external memory (e.g. DDR memory) bus, or even allow the external memory to be set into some low(er) power mode, down to being turned off completely. However, although having a large on-chip memory is beneficial from this power saving standpoint, it is very expensive to provide a large on-chip memory from the semiconductor area point of view.

Accordingly, it is proposed to use an already existing, but underused resource—the CPU local cache memory (or memories, where there is more than one provided, e.g. in a multicore processor), to store (in full or part) the buffer data when the respective cache memory is otherwise not in use. As it happens, this is often the case when the computing systems are in the afore-mentioned low activity use-cases.

The cache memory may be re-used (e.g. as a content buffer) by providing access to that cache to other processing entities within the same computing system (e.g. any external module or processing-capable entity within the computing system, other than the CPU(s) to which the cache memory is nominally originally provided before the invention is implemented), and most beneficially, to processing entities formed on the same semiconductor die as the cache memory and/or CPU(s) (e.g. SoC, multicore processors, etc).

As a more specific example, L2 cache memory provided for use by a main CPU in the computing system could be considered for re-use in the above use-case, for when that main CPU is not otherwise active. A specific example use-case is that of a display refresh mode in a mobile device (such as smartphone or tablet), when the display data is already processed ready for streaming to the display, therefore may need to be (temporarily) stored somewhere before actual display by a display process that may be managed by a separate image/display processor without CPU involvement.

Unfortunately, in some situations, cache memories, especially Level 2 cache memory, can keep “leftovers” of the data the CPU was processing with/on previously. If this is secure data (e.g. encryption keys, etc) that should not be disclosed to any non-authorised entities (e.g. unauthorised admins/users/processes/etc), additional action may be taken to avoid unwanted data disclosure within the computing system.

Accordingly, it is optionally proposed to further provide in the disclosed method an active forced writing to a part or the whole of the cache memory, to thereby replace the cache memory content with meaningless data, so that it may not be accessed by an un-authorised entity, i.e. the method may further include obfuscating the cache memory data, for example by erasing the cache data in any way that makes critical (e.g. secure) data no longer retrievable from the cache memory.

This active cache memory erasure/overwrite may be done in hardware automatically, before any hardware switching of cache memory control to an entity external to the CPU. It may be done by using dedicated additional hardware formed on the same semiconductor die as the cache memory, or via a modified CPU cache memory controller. For example, it may be carried out by a relatively simple Direct Memory Access (DMA) unit with little or no requirement for configuration. Hardware control may be used to ensure that there is no possibility that control may be hijacked by suitably crafted software (e.g. Trojan, viruses, or any other form of unauthorised software that has potential malicious intent or use).

Examples of the present invention may therefore provide a method and apparatus for adaptively allowing access to a CPU dedicated cache memory, for use by some other processing entity within an overall computing system, so that the cache memory may be used when the CPU for which the cache is originally nominally provided is not otherwise making use of that cache memory. It may do this is a secure way, so that any secure data within the cache memory is not opened for access by other portions of the overall computing system, and in particular is not made available to the system administrator, or any other users or processes within the computing system that are not authorised to access the (assumed) secure cache data. The cache memory may be any cache memory within a computing system; however, particular advantages accrue when the cache memory is of a relatively large size. The cache memory may be level 2 or level 3 caches (or any other cache memory that is of large enough size to contain a useful amount of data for the use-case of the other entity making use of the cache memory whilst the original CPU/GPU for which the cache memory was nominally provided is in a low activity/power state—e.g. a dedicated on-chip display memory being used for non-display data), and it may be a shared cache of multiple CPUs operating in a multi-core processing environment.

The security of data held within the CPU cache memory prior to the cache memory being made available for access by other entities may be provided by deleting, overwriting or otherwise destroying (or obfuscating/obscuring) the data/data integrity of the (previous) cache memory content data. In cases where the data security integrity is provided by overwriting the cache data prior to allowing access to entities external to the CPU (or CPUs) to which the cache was originally nominally provided (prior to the invention being implemented), the overwriting of the pre-existing cache data may be carried out by any suitable writing methods, and may include, but is not necessarily limited to: writing random data, writing all zero data, writing all 1 data, and the like. Data may be (re-) written multiple times, with each writing cycle using a different (e.g. opposite, data—i.e. if all 0's were written previously, all 1's may be written the next write cycle, and vice versa) or the same data.

The cache memory is generally made available to other processing entities within the computing system when the CPU for which the cache memory is primarily provided is assessed to be or will be, in a low activity state (e.g. a low level of MIPS—Millions of Instructions Per Second or the like). The enablement of the invention may also include moving any processing from the CPU having the cache, to another CPU within the computing system, so that the processing may be continued thereon. It may be the case that this movement of processing from one CPU/core to another CPU/core is what causes or enables the original processing unit/core to be able to be put into a lower power mode. The example methods and apparatuses may therefore actively look to move processing from a core/CPU with a large(er) directly associated cache memory to a core/CPU with a small(er) (or no) directly associated cache memory (at least at level 2 and above—level 1 cache is usually present but too small to be of importance with respect to examples of this invention), so that the larger cache is made available for use by another entity in the computing system.

An example use-case is display self-refresh (e.g. for a tablet or smartphone) whilst it is in standby mode—i.e. when the smartphone (tablet, or any other mobile device) has no activity and the touch screen (or keyboard, or any other input device) is not activated (e.g. pressed) and so the (main) CPU enters standby mode. Even though the device is powered down to some extent, a display should still continue to be presented to the user (e.g. typically a rendition of the last screen when the tablet was in normal use mode). Given modern aggressive power saving protocols in use with mobile devices, the entering of a low power mode can also happen while the user reads the content (e.g. text) from the screen—i.e. the mobile device may power down the main CPU whilst only an already generated piece of graphics is being displayed. In such an example use-case, the display controller on the, for example, SoC chip forming the bulk of the mobile device may have to continue to send data from a display buffer, which is usually placed in the external memory, even though it is not actually changing. In this “display only” mode, when the invention is implemented, the display buffer can instead be placed in the cache of the disabled (or lower power state) CPU, so that it may be used as an on-chip display buffer memory, thereby overcoming the need to use the external memory. Hence power may be saved by powering down all or a portion of the external memory.

An exemplary sequence for the method may be to put the CPU into a standby (or low power mode), flushing the cache data, setting a bit (by hardware or software) that moves control over the cache memory to another entity within the computing system, for example a RAM controller (or enable such feature in the CPU cache controller, so that it may then service access to the cache memory from an entity other than the original CPU). Hardware may then enable DMA to the cache memory (or a similar feature in the CPU cache controller), which may instigate the erasing of the cache content data (e.g. by overwriting the data inside the cache with random or otherwise meaningless data) and finally moving control of the cache memory to the other processing entity. The sequence may take other forms, such as erasing the cache memory data before enabling DMA access to the cache, or doing both at substantially the same time.

Another example could be audio playback in a low power mode. In normal mode, the audio buffer can be placed in external memory, since its power consumption is not critical. However, when the player device enters a low power mode (e.g. no button presses on the device for a while, hence the display can be powered down, whilst maintaining the playback) there may be a strong preference to put the external memory into a self-refresh mode (or another low power state). With the invention implemented, this may be done, because the audio buffer can be transferred to the cache memory freed up from use by the main CPU, since it has gone into a low power mode.

Examples of the invention may be used to allow a main CPU with a relatively large cache memory, and a core (or cores) that is/are relatively high power drawing to be powered down, whilst allowing access to that larger cache memory by a smaller CPU with a relatively lower power drawing core or cores.

Examples of the invention may provide an alternative use of the CPU cache memory as a multimedia content buffer, e.g. for use in storing display data, audio data or the like, for output whilst at least a portion of the overall computing system, including the main CPU is in a low power mode.

The methods and apparatus described herein may also be viewed as methods and apparatus to reduce power usage in a computing system, because for example, using an on-die CPU cache memory to store buffer-able data (at least for a time limited period, i.e. temporarily) that would otherwise have to be stored in and accessed from the external memory, that external memory may be powered down, and hence the computing system can realise power savings in the computing system as a whole. This may be particularly useful in mobile device applications, and/or implementations having a large degree of semiconductor integration, for example, System on Chip implementations of multimedia and/or applications processors.

The following examples of the invention will be cast in the context of using display buffers to store rendered graphics data prior to display, but the invention is not so limited, and in fact any alternative use for the CPU cache memory is envisaged.

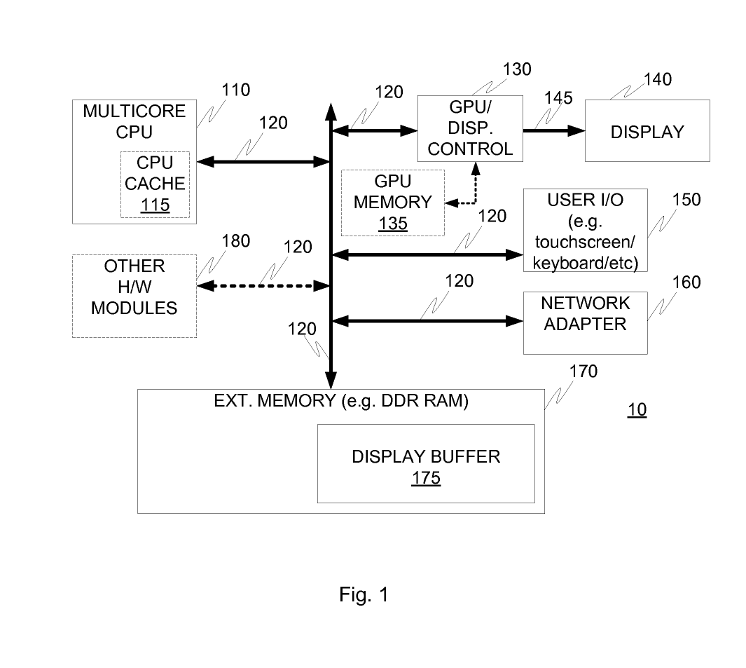

FIG. 1 shows a schematic diagram of a first discrete processor based example computing system 10 to which the invention may apply, for example a desktop PC, laptop or the like.

The discrete processor based example multimedia computing system 10 of FIG. 1 comprises a main CPU 110 (which is multicore in this specific example, but the invention is not so limited and may apply to any number of general processing cores), that includes a local (to the) main CPU cache memory 115 (for example level 1 or 2 cache) for temporarily storing data for use by the CPU 110 during its operation. The CPU 110 may be connected to the rest of the computing system 10 by any suitable communications links. For example, by a common bus 120 (as shown), but may also be connected by a set of dedicated links between each entity (e.g. CPU, memory, network adapter, etc) within the computing system 10, or a combination of shared buses for some portions and dedicated links for others. The invention is not limited by the particular form of communications links in use in respective portions of the overall computing system 10. Thus, entities within the computing system are generally able to send and/or receive data to and/or from all other entities within the computing system 10.

In the example shown in FIG. 1, the discrete processor based example (e.g. multimedia) computing system 10 further comprises a GPU/display control unit 130, potentially operatively coupled to a GPU memory 135 either directly (as shown) or via a shared but (not shown). The GPU/display control unit 130 may be a combined entity (as shown in FIG. 1), including both the GPU and the necessary physical links (e.g. line drivers, etc) to the display 140 (e.g. Liquid Crystal Display—LCD, plasma display, Organic Light Emitting Diode—OLED, or the like), or may only include the necessary physical links (e.g. line drivers, etc) to the display 140, for example where there is no actual GPU, and instead the graphics are produced by the CPU 110 potentially in a dedicated graphics rendering mode or similar. This is to say, the discrete processor based example computing system 10 may not include the ‘discrete’ graphics acceleration provide by having a GPU (where ‘discrete’ here may not mean separation of the GPU from the CPU in terms of semiconductor die, but does mean there is separate dedicated graphic rendering capability). Where a GPU is present, the computing system 10 may further include a dedicated GPU memory 135, for use in processing graphics prior to display. Where such a GPU memory is not present, the GPU (or CPU in graphics mode) may use the external memory 170 instead.

The GPU and/or display adapter 130 may be operably connected to the display 140 via dedicated display interface, 145, to drive said display 140 to show the graphical/video output of the discrete processor based example computing system 10. Examples of suitable dedicated display interfaces include, but are not limited to: HDMI (High Definition Multimedia Interface), DVI (Digital Video Interface) or analog interfaces, or those functionally alike.

The discrete processor based example computing system 10 may further include one or more user input/output (I/O) units 150, for example, to provide connection to, and therefore input from a touchscreen, mouse, keyboard, or any other suitable input device, as well as driving suitable output devices such as speakers, fixed function displays (e.g. 9 segment LCD displays, LED flashing signal lights, and the like). The user I/O unit 150 may, for example, further include or comprise a Universal Serial Bus (USB) controller, Firewire controller, Thunderbolt controller or any other suitable peripheral connection interface, or the like. The discrete processor based example computing system 10 may also further include a network adapter 160, for coupling/connecting the discrete processor based example multimedia computing system 10 to one or more communications networks. For example, WiFi (e.g. IEEE 802.11b/g/n networks), wired LAN (e.g. IEEE 802.3), Bluetooth, 3G/4G mobile communications standards and the like. The computing system 10 may also include any other selection of other hardware modules 180 that may be of use, and hence incorporated into the overall computing system 10. The optional nature of these hardware modules/blocks 180 is indicated by their dotted outlines.

The computing system 10 may also include a main external memory subsystem 170, operatively coupled to each of the other above-described entities, for example, via the shared bus 120. In the context of the present invention, the external memory 170 may also include a portion (either permanently dedicated, or not, but otherwise assigned on boot up) for storing display data ready for display, known as a display buffer 175.

The invention is not limited by any particular form of external memory 170, display 140, User I/O unit 150, network adapter 160, or other dedicated hardware modules 180 present or in use in the future.

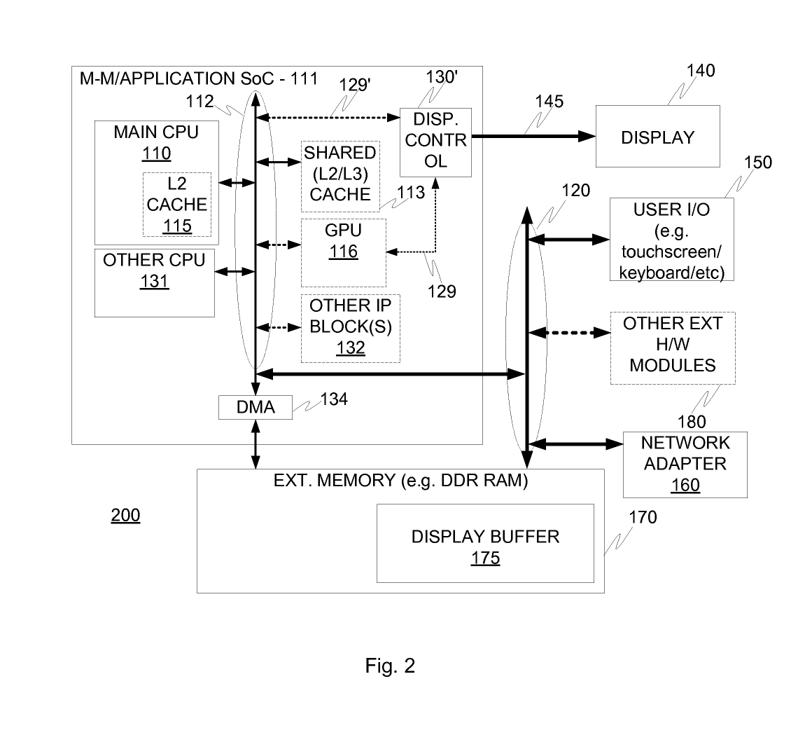

FIG. 2 shows a similarly capable computing system to FIG. 1, except that the computing system is formed as a SoC computing system 200, i.e. formed predominantly as a highly integrated multimedia/applications SoC processor 111. In such a situation, more of/most of the overall system is formed within the same IC package (e.g. formed from two or more separate silicon dies, but suitably interconnected within the same package) and/or formed on the same singular integrated circuit semiconductor die itself. However, in this case, some portions of the overall computing system 200 may still be formed from other discrete entities. This form of multimedia computing system is used more often in the portable and/or small form factor device use cases, for example, in the form of laptops, tablet computers, personal media players (PMPs), smartphones/feature phones, etc. However, they also find use in other relatively low cost equipment areas, such as set top boxes, internet appliances and the like.

The majority of the SoC implemented multimedia computing system 200 is very similar to, or indeed the same as for FIG. 1, therefore they use the same references, and they act as described above (e.g. network adapter 160, User I/O 150, etc).

However, there are some potential key differences. For example, the SoC 111 has its own internal bus 112 for operatively coupling each of the entities on the single semiconductor die (again, a shared bus is used in this example, but instead they could equally be one or more dedicated links, or more than a single shared bus, or any other logically relevant/suitable set of communications links) to allow the different entities/portions of the circuit (i.e. integrated entities—CPU 110, Other CPU 131, etc) of the SoC to communicate with each other. A SoC multimedia processor 111 may incorporate more than one CPU for use—thereby allowing multi-processor (e.g. core) data processing, which is a common approach to provide more processing power within a given power (i.e. current/voltage draw/etc) envelope, and without having to keep on increasing CPU operating frequencies. Due to having multiple CPU's on the same semiconductor die, there may be provided some form of shared cache—e.g. shared L2 or L3 cache 113. This shared cache may still be “locked” to a subset of cores/PUs, i.e. only provided for use/access by that subset of cores. The SoC based computing system 200 may include other IP block(s) 132, dependent on the needs/intended uses of the overall system 200, and how the SoC designer provides for those needs/intended uses (e.g. whether he opts to provide dedicated processing resources for a selected operation, or whether he just relies on a general processor instead). In the example of FIG. 2, there is also included a Direct Memory Access (DMA) unit 134, to allow direct access to the external memory 170, and especially, in the context of this invention, the external memory display buffer 175. Another difference to FIG. 1 is the provision of separate GPU 116 and display controller 130′ (the use of indicating a different form of display controller, i.e. in this case without GPU).

In FIG. 2, there are two different example internal SoC graphic sub-system setups shown, but the invention is not so limited. These primarily differ in how the respective graphics entities (CPU 110, GPU 116, etc) communicate with each other.

For example, the first may involve the CPU 110 (when operating in some form of (dedicated) graphics mode) or GPU 130 communicating via the internal on-die shared bus 112, particularly including the display control communications portion, 129′, i.e. the portion coupling the display control unit 130′ to the shared bus 112. The other method may be via a dedicated direct communications link, e.g. link 129 between, for example, the GPU 116 and display control unit 130′ (a similar direct communications link is not shown between the CPU 110 and display control unit 130′, but this form may equally be used where there is no GPU in the SoC). In the example shown, the display control unit 130′ and GPU 116 are integrated onto the same SoC multimedia processor 111, but may equally be formed of one or more discrete unit(s) outside of the SoC semiconductor die, and which is connected by some suitable dedicated or shared interface (not shown).

Regardless of how the CPU/GPU is connected to the display control unit 130′, they may also be operatively coupled to the display buffer 175, for example located in the external memory subsystem 170. This so called external memory based display buffer 175 is accessible, in the example shown, via the internal shared bus 120, and the DMA unit 134 connected thereto. In this way, the display data is communicable to the display 140 via the display control unit 130′ under control of the CPU 110 and/or GPU 116. The display buffers may also be included in the display adapter (not shown). Also, it will be appreciated that other suitable direct or indirect connections between the respective entities involved in rendering the display may be used, depending on the particular display driver circuitry configuration in use.

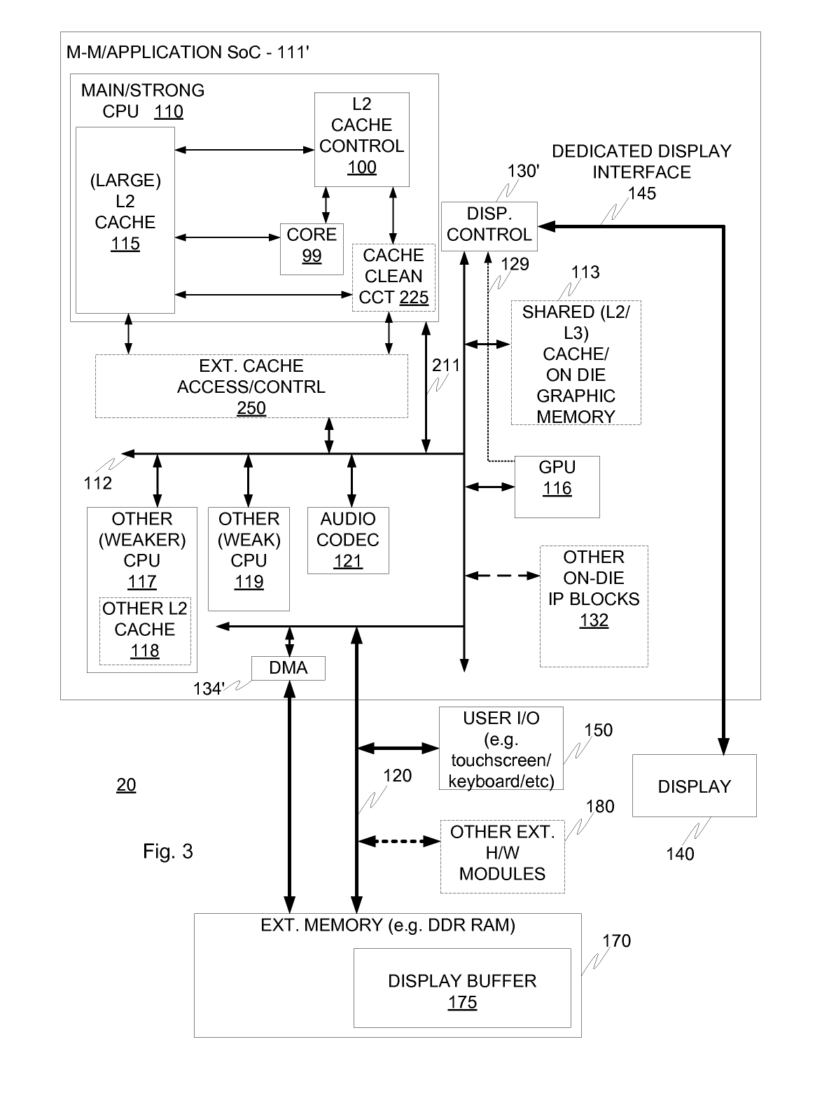

FIG. 3 shows a more detailed schematic diagram of an example SoC computing system 111′ according to an example of the invention. In the most part, this Figure is substantially similar to FIG. 2, and so like references are used, corresponding to the description above. However, in this Figure, there can be seen a main/strong CPU 110, another (potentially weaker) CPU 117 and a weak CPU 119. The use of the terms strong/weaker/weak may be based upon the amount/size of cache memory available to the respective CPU, where ‘strong’ means there is a large cache memory (in the example shown, a large L2 cache 115), ‘weaker’ is where there is a (relatively) small(er) cache memory (in the example shown, other L2 cache memory 118), and ‘weak’ may be where there is no cache memory available.

In examples having these different “strengths” of CPU, the invention may be used to allow the cache memory from, for example, the ‘strong’ or ‘weaker’ CPUs (i.e. those with a cache at all) to be used by other entities within the computing system, and in particular those CPU(s) without any cache. Thus cache memory use may be shunted from strong to weaker CPUs, strong to weak CPUs, weaker to weak CPUs, from a CPU with cache to a non CPU entities, e.g. audio codec or the like, and any other suitable combination.

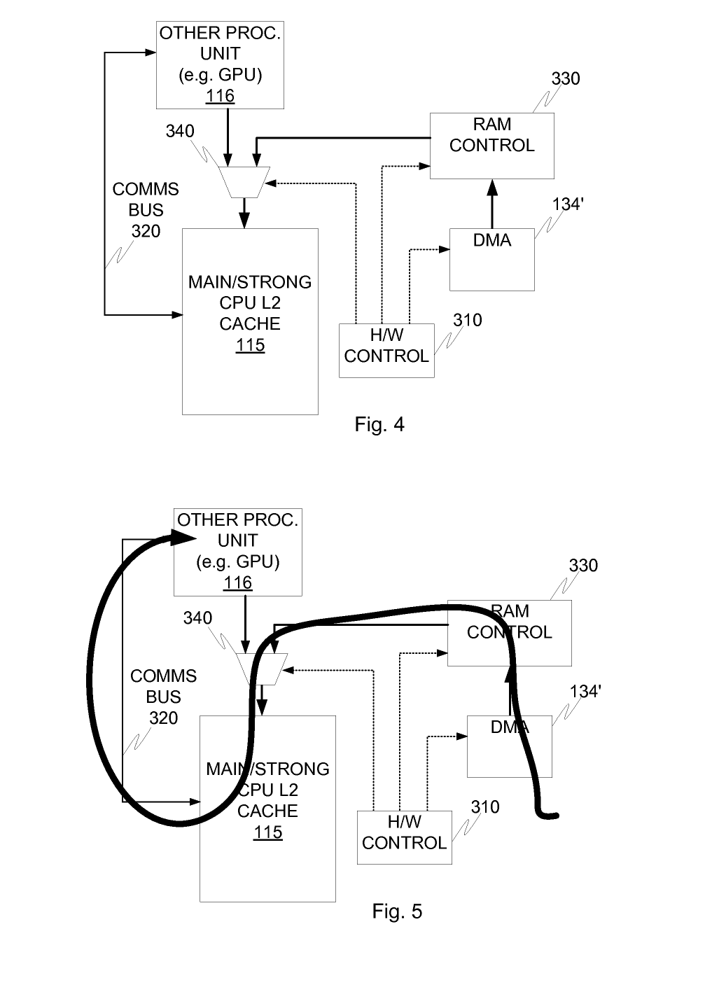

The main/strong CPU 110 includes a CPU core 99 (but may equally include multiple cores, not shown), operatively coupled to a L2 cache controller 100 and L2 cache memory 115. The main CPU also includes a cache cleaning circuit 225, as one form of implementation of the invention, which may be used instead of integrating the described functionality into the cache memory controller 100 itself (hence the dotted nature of the outline for the cleaning circuit 225). The cache controller may be the cache controller of the cache whose use is being moved. The main CPU may be operatively coupled to the internal bus of the SoC 112 to allow the main CPU to communicate with the rest of the computing system as a whole. For example, by either a direct link 211, which may be used in the case where the cache memory controller 100, or another processing (general purpose or dedicated/fixed function) entity within the main CPU includes all the functionality described below (i.e. regarding the ability to transfer control of the main CPU cache memory to at least one other entity within the computing system, such as other CPUs 117, 119, or even GPU 116, audio codec 121 or the like). Alternatively, specialist additional external cache access/control hardware (e.g. unit 250) may be included, through which the CPU and/or CPU cache memory may be accessed. A combination of (at least portions of) both implementations may also be used, for example, having the usual links 211 operative when the main CPU 110 is in normal operating mode, and having external cache access/control unit 250 and/or the cache cleaning circuit 225 available and operative when the main CPU 110 is in a low power or off mode. The SoC processor 111′ may also include an adapted DMA controller, which is explained with more reference to FIGS. 4 and 5.

The cache cleaning circuit 225, if used as a way to implement the invention, may be arranged to carry out cleansing of the data already existing in the cache memory 115 (i.e. the instructions data, or the data on which the instructions operate, or the data which is a result of processing by the main CPU until it is put into a low power mode, or similar). The cache cleaning circuit 225 is there to effectively obscure the data from the external entity gaining access to the main CPU cache memory, so that it cannot make any use of that data. This is particularly so that the existing cache data security is not compromised in any way (which could otherwise provide a means for software to hijack assumed secure computing environments and the like). The data may be obscured by any suitable means (such as, but not limited to erasing the data, writing random data, or writing constant value data, such as all 1's or all 0's), and may only require a portion of the data to be actually erased/overwritten, i.e. so the data loses context, and hence becomes effectively unusable. Modifying (i.e. erasing or overwriting) only portions of the data may be not only sufficient to maintain security, but it may also be carried out more quickly, with less power draw and potentially with less wear of the memory (i.e. does not reduce memory operative lifetime to the same degree), depending on memory type(s) in use in the cache memory 115. If the invention is implemented as a modified cache controller 100 for the main CPU, then the cache cleaning circuit 225 may be formed as part of the modified cache controller (this form of implementation is not shown).

The particular way in which other entities within the computing system may access the main CPU cache memory 115 is not intended to limit the invention, in its broadest sense. The described external access to a CPU cache memory may also equally apply to any and all CPUs having an associated cache memory, or equivalent processing resources (such as, for example, GPUs, Hardware codecs, DSPs and the like) within a computing system. For example, the on-die shared cache 113 may be at least in portion, a graphics cache (e.g. display buffer), nominally for exclusive use of the GPU 116. In this case, an example of the invention may be applied to allow access to the graphics cache portion by another non-graphics entity, for example hardware audio codec block 121 (for example, to provide for the low power audio playback without display example use-case mentioned above).

Thus, whilst the described examples are in terms of accessing the cache associated with a strong main CPU, other CPU types are envisaged.

The remaining units of FIG. 3 are generally functionally similar to FIGS. 1 and 2, and as such use the same references, and operate as described above with reference to those Figures, for example the potential inclusion of other IP blocks 132 (i.e. pre-prepared functional units, for example application specific cores, or the like).

FIG. 4 shows an example hardware implementation of the cache memory access and control architecture according to an embodiment of the present invention. This figure only shows the relevant portions of an overall circuit, for clarity.

Hardware controller 310, which may be in the form of a modified CPU cache controller or dedicated hardware units as described above with reference to FIG. 3, controls the access to the CPU cache memory 115 by another processing resource (i.e. entity within the computing system), such as GPU 116, other CPU 117/119, or the like, through switching fabric means, such as multiplexer 340. The switching fabric means 340, also provides access to the CPU cache memory 115 for data transfer thereto, for example, by allowing access to the cache memory 115 by external memory 170. This is so that, for example, data relevant to the GPU 116 may be stored within the cache memory 115, after control has switched to the GPU 116. Direct external memory access may be made, for example, through a dedicated DMA unit 134′. There may also be a bi-directional communication link 320, e.g. bus or dedicated link, connecting the other processing unit, e.g. GPU 116, directly to the cache memory 115 that may only be made operative as a result of/during the switch from main CPU (e.g. core 99) control of the cache memory 115, to GPU 116 control of the cache memory 115. The bi-directional communications link 320 may be a much higher bandwidth communications link than the multiplexed link through multiplexer 340. This is to say, the multiplexed link may be a control link, and the bi-directional communications link 320 may be a substantive data link.

FIG. 5 shows an example data flow path within the example circuitry of FIG. 4. The arrow shows how the data from external memory may be loaded directly into the cache memory 115 through the RAM control unit 330 and DMA unit 134′ connected once the cache memory is under the control of the other processing unit, for example GPU 116, so that the data is available for use by that other processing unit, e.g. GPU 116, other CPU 117/119, etc until such time that the main CPU 110 needs access to its cache memory, for example when it comes out of a sleep state/low power mode.

The availability of the cache memory 115 for use by other processing resources may be time limited, and/or revocable, so that the main CPU 110 does not lose control/use of the cache memory (either totally, or for long enough to cause problems, e.g. delays in processing further data). It is to be noted that throughout this disclosure, where reference is made to CPU, it may be considered to mean a reference to the one or more cores within that CPU, that singularly or together define the ‘processing unit’.

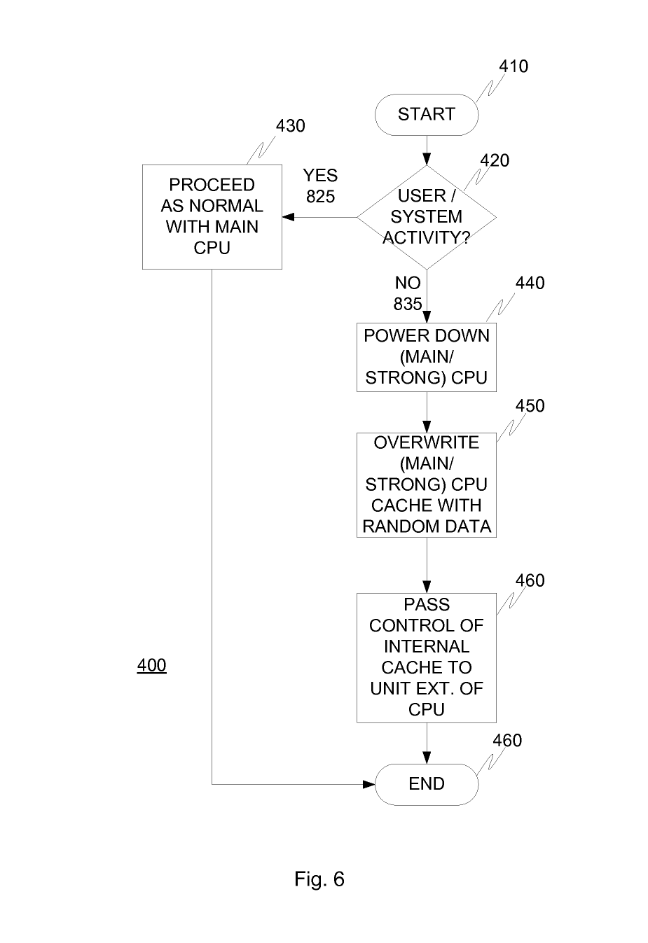

FIG. 6 shows an example flow diagram of a method of controlling CPU cache memory 115 use by an entity external to the CPU 110 for which the cache memory 115 is/was originally nominally provided according to an example embodiment of the invention.

The method may start 410 and then proceed to determine if there is any user or system activity that requires the main CPU to maintain itself in normal operating mode, or equivalent (i.e. a state that may require use of the CPU cache memory 115 by the related CPU 110). If so, (i.e. a positive assessment YES 825), then the method proceeds as normal, i.e. the (Main) CPU is kept operating as normal 430 and the method ends 460 for now. Alternatively, when there is no user/system activity that requires the main CPU to maintain in normal mode or access to the related cache memory (a negative assertion, NO 835), then the method may power down 440 the main CPU to which the relevant cache memory 115 is attached/integrated with/nominally mainly assigned. Then the method may obscure the data already existing in the cache memory, for example, by overwriting the cache memory data with random data 450. Then the method may pass control of the cache memory from the main CPU to the other unit external to the main CPU (i.e. any processing unit not the main CPU). The method is then effectively ended 460, until such time as the main CPU needs access back to the cache memory.

When a main CPU is given back access to the cache memory, the cache memory may not have any data relevant to the CPU within it anymore. In which case, the cache memory may be reloaded with relevant data, largely in the usual way. This step may not need any security based data erasure, as before, as the CPU may be sufficiently trusted to have access to the (temporary) data that was put into the cache memory 115 for use by the other/external entity. However, in some implementations, the cache memory may be again overwritten or erased (or use any other suitable means to destroy the external entity's data, if that data should not be made accessible to the CPU either).

Example portions of the invention may be implemented as a computer program for a computing system, for example multimedia computing system, or processor therein, said computer program for running on the multimedia computer system, at least including executable code portions for creating digital logic that is arranged to perform the steps of any method according to embodiments the invention when run on a programmable apparatus, such as a computer data storage system, disk or other non-transitory and tangible computer readable medium. For example, examples of the invention may take the form of an automated Integrated Circuit design software environment (e.g. CAD/EDA tools), used for designing ICs and SoCs in particular, that may implement the afore-mentioned and described cache access control and security invention.

A computer program may be formed of a list of executable instructions such as a particular application program and/or an operating system. The computer program may for example include one or more of: a subroutine, a function, a procedure, an object method, an object implementation, an executable application, an applet, a servlet, a source code, an object code, a shared library/dynamic load library and/or other sequence of instructions designed for execution on a suitable computer system, such as an Integrated Circuit design system.

The computer program may be stored in a non-transitory and tangible fashion, for example, internally on a computer readable storage medium or (after being) transmitted to the computer system via a computer readable transmission medium. All or some of the computer program may be provided on computer readable media permanently, removably or remotely coupled to a programmable apparatus, such as an information processing system. The computer readable media may include, for example and without limitation, any one or more of the following: magnetic storage media including disk and tape storage media; optical storage media such as compact disk media (e.g., CD-ROM, CD-R, Blueray, etc.) digital video disk storage media (DVD, DVD-R, DVD-RW, etc) or high density optical media (e.g. Blueray, etc); non-volatile memory storage media including semiconductor-based memory units such as FLASH memory, EEPROM, EPROM, ROM; ferromagnetic digital memories; MRAM; volatile storage media including registers, buffers or caches, main memory, RAM, DRAM, DDR RAM etc.; and data transmission media including computer networks, point-to-point telecommunication equipment, and carrier wave transmission media, and the like. Embodiments of the invention are not limited to the form of computer readable media used.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to graphics overlay data examples of embodiments of the invention. It will, however, be evident that various modifications and changes may be made therein without departing from the broader scope of the invention as set forth in the appended claims. For example, the method may equally be used to compress data that is not used as much as some other data.

The terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be used, or replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, tablets, notepads, personal digital assistants, electronic games, automotive and other embedded systems, smart phones/cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise stated as incompatible, or the physics or otherwise of the embodiments prevent such a combination, the features of the following claims may be integrated together in any suitable and beneficial arrangement. This is to say that the combination of features is not limited by the specific form of claims below, particularly the form of the dependent claims, and as such a selection may be driven by claim rules in respective jurisdictions rather than actual intended physical limitation(s) on claim combinations. For example, reference to another claim in a dependent claim does not mean only combination with that claim is envisaged. Instead, a number of claims referencing the same base claim may be combined together.

1. A processor for use in a computing system, said processor comprising:
at least one Central Processing Unit (CPU);
a cache memory coupled to the at least one CPU; and
a control unit coupled to the cache memory and arranged to:
obscure the existing data in the CPU cache memory, and
assign control of the CPU cache memory to at least one other entity within the computing system.

2. The processor of claim 1, wherein the control unit is arranged to obscure the existing data in the cache memory by being arranged to render the existing data inoperative or unreadable to the at least one other entity within the computing system once that entity has control of the CPU cache memory.

3. The processor of claim 1, wherein the control unit is arranged to obscure the existing data in the cache memory by being arranged to:
overwrite at least a portion of the existing data within the CPU cache memory, or
delete at least a portion of the existing data within the CPU cache memory.

4. The processor of claim 3, wherein the at least a portion of the existing data comprises all of the existing data within the CPU cache memory.

5. The processor of claim 1, wherein assignment of control of the CPU cache memory to the at least one other entity within the computing system further comprises providing the at least one other entity within the computing system at least one of read access or write access to the CPU cache memory, wherein the control unit is further arranged to provide said at least one of read access or write access to the CPU cache memory to the at least one other entity in the computing system.

6. The processor of claim 1, wherein an obscuring of the data and an assignment of control of the CPU cache occurs in response to at least one of a request for access to the CPU cache by the at least one other entity or as a result of the CPU entering a lower power state.

7. The processor of claim 1, wherein the control unit is a cache controller or a DMA unit.

8. The processor of claim 5, wherein the at least one of read access or write access is at least one of time limited or revocable, dependent on a need of the CPU unit to access the CPU cache memory.

9. The processor of claim 1, wherein the processor is a system on chip multimedia applications processor having at least one main CPU and at least one other CPU, and wherein the at least one other CPU is one of the at least one other entity within the computing system.

10. The processor of claim 1, wherein the CPU cache memory is arranged to be used by the at least one other entity within the computing system as a multimedia buffer memory.

11. A method of using a CPU cache memory for non-CPU related tasks in a computing system comprising:
obscuring existing data in the CPU cache memory; and
assigning control of the CPU cache memory to at least one other entity within the computing system.

12. The method of claim 10, wherein obscuring existing data in the CPU cache memory comprises rendering the existing data inoperative or unreadable to the at least one other entity within the computing system once that entity has control of the CPU cache memory.

13. The method of claim 10, wherein obscuring existing data in the CPU cache memory comprises one or more of:
overwriting at least a portion of the existing data; or
deleting at least a portion of the existing data.

14. The method of claim 10, further comprising flushing the cache prior to allowing access to the cache by at least one other entity within the computing system

15. The method of claim 10, wherein assigning control of the CPU cache memory to at least one other entity within the computing system comprises providing at least one of read access or write access to the CPU cache memory by the at least one other entity within the computing system.

16. The method of claim 15, wherein the at least one of read access or write access is at least one of time limited or revocable, dependent upon a need of the CPU unit to access the CPU cache memory.

17. The method of claim 10, wherein providing the at least one of read access or write access to the cache memory comprises providing a Direct Memory Access to the cache.

18. The method of claim 10, wherein assigning control of the CPU cache memory to another entity within the computing system is carried out in order to provide a temporary multimedia buffer memory.

19. The processor of claim 1, wherein the CPU cache memory is a level 2 or level 3 cache memory on the same semiconductor die as the CPU.

20. (canceled)
